(19) United States
(12) Patent Application Publication
(10) Pub. No.: US 2007/0052749 A1
(43) Pub. Date: Mar. 8, 2007

(54) INK DISCHARGE DEVICE FOR PREVENTING CAP FROM CLOGGING

(76) Inventor: Chih-Hung Chen, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/469,896

(22) Filed: Sep. 4, 2006

(30) Foreign Application Priority Data
Sep. 6, 2005 (TW) 094130613

(51) Int. Cl. B41J 2/165

(52) U.S. Cl. 347/29

(57) ABSTRACT

The present disclosure provides an ink discharge device of a printing device. The ink discharge device contains a first cap, a second cap, and a pump. The first cap is utilized to cap a first nozzle area of the printing device has a first connecting terminal and a second connecting terminal. The second cap is utilized to cap a second nozzle area of the printing device has a third connecting terminal coupled to the second connecting terminal. The pump coupled to the first connecting terminal discharges the ink on the first and the second nozzle areas through the first and the second caps.

### BACKGROUND OF THE INVENTION

1. Field of the Invention

The present invention relates to an ink discharge device, and especially to an ink discharge device capable of preventing a connecting terminal or a tube of a cap from becoming clogged.

2. Description of the Prior Art

Recently printers in the market place mostly contain an ink discharge device. The ink discharge device primarily utilizes a cap-carrying device to cover the nozzle of an inkjet head. The cap-carrying device is coupled to a tube, which has one terminal connected to the cap-carrying device and the other terminal connected to a pump. The pump discharges the air in the tube and the cap, which covers the inkjet head. As a result of the pump discharging action, a vacuum effect is achieved for the tube and the cap such that the ink in the inkjet head is drained out. As a result, the wet ink thereby pushes out the dry ink wherein the dry ink would otherwise cause clogging of the nozzle.

There are several issues of importance that should be taken into consideration. Specifically, for example, care must be directed toward a cap design. Because the cap directly touches the ink, the material of the cap must, to a certain degree, possess an anti-chemical property. Moreover, the cap must also possess a good elasticity such that the cap can cover the inkjet head tightly in a sealed fashion. The cap can be designed in two ways. The cap can be designed as an enclosed cap or alternatively, with a hole on the cap. The primary purpose of the hole is to prevent any ink in the inkjet head from being pushed or forced back deeper into the inkjet head. For example, ink can be forced into the inkjet head by the compressed air in the cap when the cap is moving up to cover the inkjet head (i.e., when the cap is approaching the inkjet head. If the ink in the inkjet head is pushed/forced back deeper inside of the inkjet head, then it will become very difficult to clean the inkjet head. Care must be taken regarding the hole on the cap. The hole must be designed by following a defined specification of the inkjet head. Under basic conditions, wherein the pressure in the cap does not change when the cap is moving up to approach the inkjet head, the length and the cross section of the hole should be as long as possible and as small as possible to prevent the ink from evaporating to the environment.

In the process of setting up an ink discharge device on a service station (or a maintenance station), every cap-carrying device must have a hole to be coupled to a tube, which is further connected to a pump. As mentioned above, the length and the cross section of the hole should be as long as possible and as small as possible to decrease the evaporation rate of the ink in the nozzle when the pump is not in operation. Please refer to FIG. 1. FIG. 1 illustrates a diagram of a prior art cap. The cap 10 has a hole in the center utilized to discharge the air in the cap 10. Please refer to FIG. 2 for additional detail. FIG. 2 illustrates a diagram of a side view of the cap 10.

Because the hole 12 on the cap 10 is very small, it is easy for said hole to become clogged. The dry ink has probably clogged the hole 12 if the composition of the ink discharged by the cap 10 is thick. Therefore, in this situation, the cap 10 is no longer able to clean the inkjet head that the cap 10 covers. As a result, the ink is subject to becoming thick or even dry out when the ink is exposed to the air. However, it is known that some ink is not subject to this drying phenomenon. More specifically, some ink will not become thick or even dry out when it is exposed to the air. For example, the most commonly utilized ink can be divided into two categories: a dye and a pigment. The dye ink will not leave behind residue or become sticky or thick after it is entirely evaporated; however, the pigment usually does become thick when it is exposed to the air. Therefore, the hole 12 of the cap 10 is probably clogged by the dry pigment.

Please refer to FIG. 3. FIG. 3 illustrates a diagram of a printer engine of a prior art ink-jet printer. The printer engine 100 primarily contains a main frame 110, an inkjet head set 120, a motor 130, a lateral axis 140, a feed axis 150, a discharge axis 160, a printing platform 170, a scrape maintenance station 180, a cap maintenance station 190, and a pump 191. The inkjet head set 120 has two inkjet heads 125 and 126 that are utilized for outputting ink. The primary function of the cap maintenance station 190 is to cover the inkjet heads 125 and 126 with caps 195 and 196 when the printer engine 100 will not be in operation for a long period of time. When the printer engine 100 is not in operation, the inkjet head set 120 moves to the cap maintenance station 190 along the lateral axis 140 under the drive of the motor 130, as shown in FIG. 4. FIG. 4 illustrates a diagram of the prior art ink-jet printer with the inkjet head set 120 on the cap maintenance station 190. In this case, the caps 195 and 196 covers the inkjet heads 125 and 126 tightly to prevent the inkjet heads 125 and 126 from being exposed directly to the atmosphere thereby preventing the ink on the nozzles of the inkjet heads 125 and 126 to dry out and therefore clogs the nozzles.

Please refer to FIG. 5, which is a simplified drawing of FIG. 4. FIG. 5 illustrates a diagram of the configuration of the inkjet heads 125 and 126, the cap maintenance station 190, and the pump 191. When the printer engine 100 will not be in operation for a long period of time, the inkjet heads 125 and 126 move to the cap maintenance station 190. The cap maintenance station 190 has two tubes 193 and 194 connected to the pump 191. Please refer to FIG. 6, which illustrates a diagram of a front view of the inkjet head 125 and 126 and the cap maintenance station 190. The caps 195 and 195, which respectively cover the inkjet heads 125 and 126, are connected to the pump 191 respectively through the tubes 193 and 194. When the pump 191 initiates operation, the pump 191 will discharge the air inside the caps 195 and 196 through the tubes 193 and 194, causing a negative pressure in the caps 195 and 196. As a result, the residual ink on the nozzles of the inkjet heads 125 and 126 is drained out, and therefore the inkjets 125 and 126 are cleaned.

Please refer to FIG. 7. FIG. 7 illustrates a diagram of the fine detailed parts of the cap maintenance station 190 and the connection between the pump 191 and the cap maintenance station 190 in greater detail. The cap maintenance station 190 has two caps 195 and 196 that are connected to the cap maintenance station 190 respectively through the springs 295 and 296. The elastic force of the spring 295 and 296 push the caps 195 and 196 to ensure a close and fitting contact with the inkjet head 125 and 126. In order to address the connection between the caps 195, 196, and the pump 191 in more detail, the cap maintenance station 190, the spring 295, and 296 shown in FIG. 7 are removed, and just remaining is the cap 195, 196, tube 193, 194, and the pump 191 as illustrated in FIG. 8. FIG. 8 shows the first connection between the caps 195, 196, and the pump 191. As shown in FIG. 8, the cap 195 is connected to the pump 191 through the tube 193, and the cap 196 is connected to the pump 191 through the tube 194. That is, when the pump 191 is working, the pump 191 discharges the ink on the inkjet head 125 through the tube 193 and the cap 195; simultaneously, the pump 191 also discharges the ink on the inkjet head 126 through the tube 194 and the cap 196 to achieve the purpose of cleaning the inkjet head 125 and 126. The connection shown in FIG. 8 illustrates a diagram of the conventional connection manner utilized in the prior art. Please refer to FIG. 9. FIG. 9 illustrates a diagram of the second connection between the caps 195, 196, and the pump 191. As shown in FIG. 9, the cap 195 and 196 are both connected to a “Y” type tube 200. The “Y” type tube 200 has three openings, wherein two openings are respectively connected to the cap 195 and 196, and the third opening is connected to the pump 191. Therefore, the pump 191 can also achieve the objective of cleaning the inkjet head 125 and 126 while the pump 191 is in operation.

As mentioned above, the most commonly utilized ink can be divided into two categories: a dye type ink and a pigment type ink. In the current market place for ink-based printers, the black color ink usually belongs to be pigment ink type. Additionally, in most of print devices used today, the usage frequency of the black color ink is greater relative to other ink colors, therefore, the hole of the cap 195 and 196 is probably more easily clogged by the dry pigment ink.

### SUMMARY OF THE INVENTION

It is therefore one of the objectives of the present invention to provide an ink discharge device to solve the above-mentioned problems.

According to an aspect of the present invention, an ink discharge device of a printing device is disclosed. The ink discharge device of the printing device includes a first cap, a second cap, and a pump. The first cap is utilized for covering a first nozzle area of the printing device, and the first cap comprises a first connecting terminal and a second connecting terminal. The second cap is utilized for covering a second nozzle area of the printing device, and the second cap comprises a third connecting terminal coupled to the second connecting terminal. The pump is coupled to the first connecting terminal for discharging the ink on the first and the second nozzle areas through the first and the second caps.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a prior art cap.

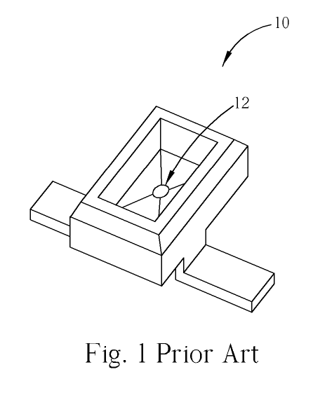

FIG. 2 illustrates a diagram of a side view of the prior art cap.

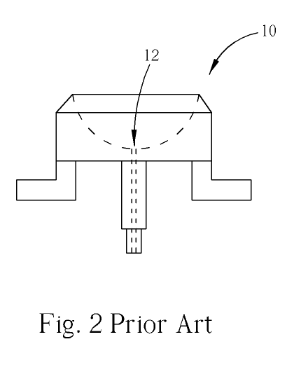

FIG. 3 illustrates a diagram of a printer engine of a prior art ink-jet printer.

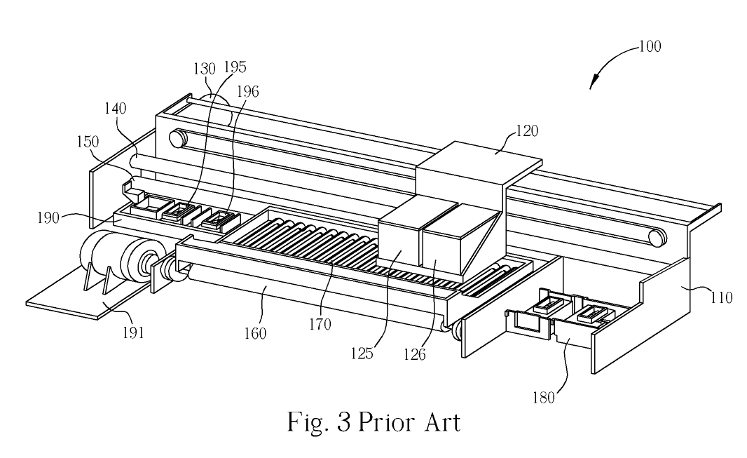

FIG. 4 illustrates a diagram of the prior art ink-jet printer with the inkjet head positioned on the cap maintenance station.

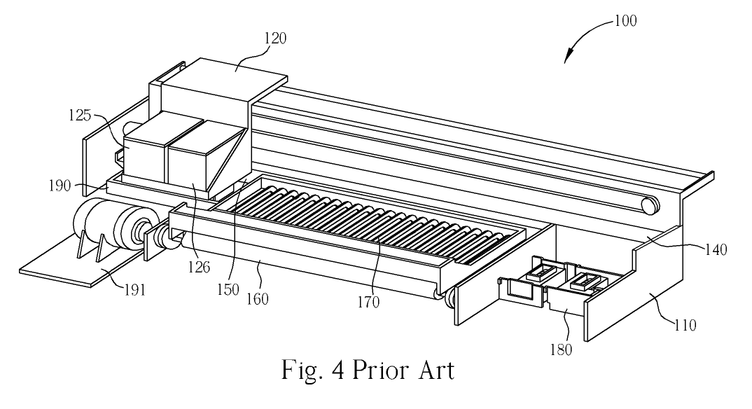

FIG. 5 illustrates a diagram of the configuration of the inkjet heads, the cap maintenance station, and the pump.

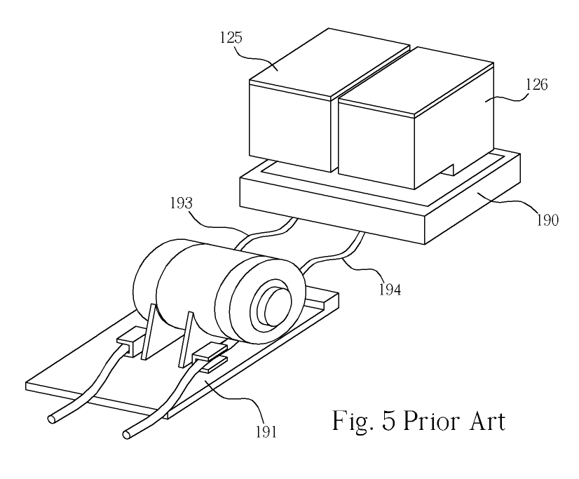

FIG. 6 illustrates a diagram of a front view of the inkjet head and the cap maintenance station.

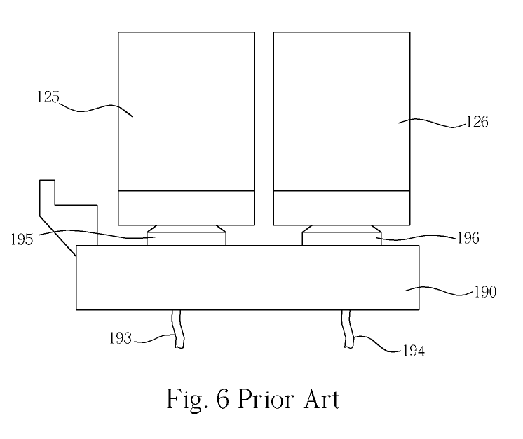

FIG. 7 illustrates a diagram of the fine detailed parts of the cap maintenance station and the connection between the pump and the cap maintenance station.

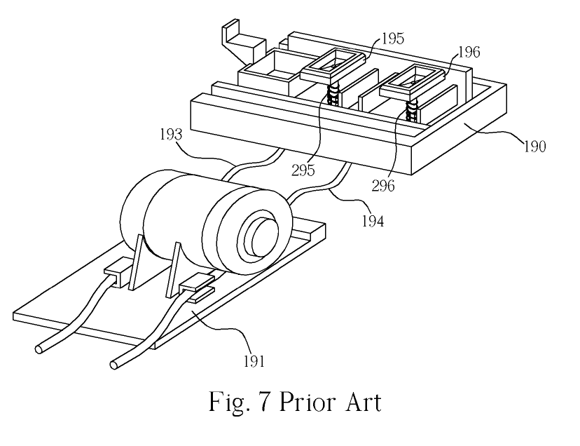

FIG. 8 illustrates a diagram of the first connection between the caps and the pump.

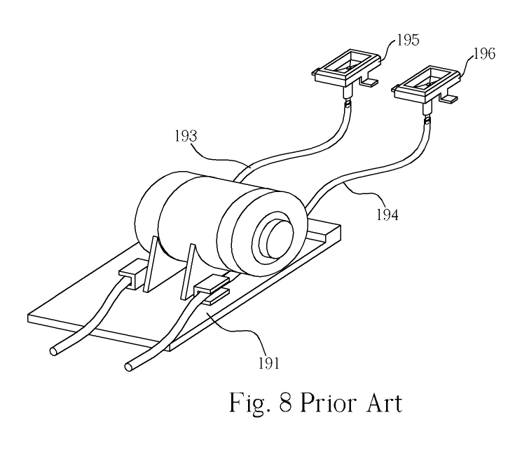

FIG. 9 illustrates a diagram of the second connection between the caps and the pump.

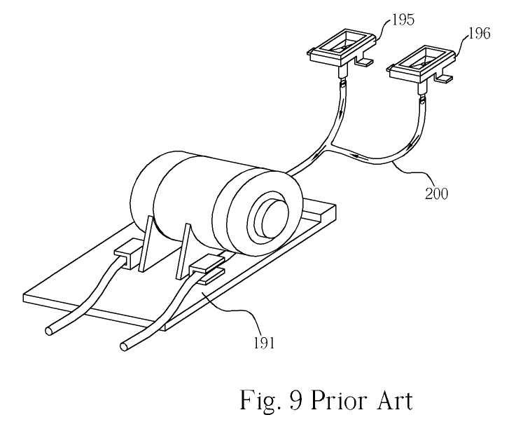

FIG. 10 illustrates a diagram of the connection between the cap and the pump according to a first embodiment of the present invention.

FIG. 11 illustrates a diagram of the connection within three caps according to the third embodiment of the present invention.

FIG. 12 illustrates a diagram of the connection within three caps according to the four embodiment of the present invention.

### DETAILED DESCRIPTION

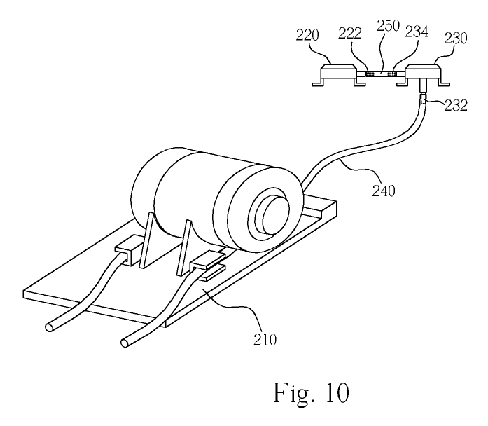

Please refer to FIG. 10. FIG. 10 illustrates a diagram that shows the connection between the cap and the pump according to a first embodiment of the present invention. As shown in FIG. 10, this embodiment includes two caps 220 and 230. This embodiment of the present invention primarily differs from the prior art in that the cap 195 and 195 in the prior art have only one connecting terminal respectively. However, in this embodiment of the present invention, the cap 230 has two connecting terminals; one connecting terminal 232 is utilized for connecting the pump 210 through the tube 240; and the other connecting terminal 234 is utilized for connecting the cap 220. The cap 220 has a connecting terminal 222, which is connected to the connecting terminal 234 of the cap 230. The connecting terminal 222 can be directly connected to the connecting terminal 234 to enforce the cap 220 and 230 connecting in a series without through any tube; or the cap 220 and 230 can be connected in a series through the tube 250 between the connecting terminal 222 and the connecting terminal 234. Regardless of the details of being directly connected, for example, the caps 220 and 230 are connected directly, or through the tube 250, the ultimate result is that the cap 230 is finally connected to the pump 210 through the tube 240. Please assume that the cap 220 is utilized for covering a first inkjet head. Furthermore, please assume that the cap 230 is utilized for covering a second inkjet head. It can easily be seen that the pump 210 can discharge the residual ink on the nozzles of the first and the second inkjet heads through the tube 240, the cap 230, the tube 250, and the cap 220 to achieve the cleaning purpose of the present invention.

As is well known to those of average skilled in the art, the pigment usually becomes thick or sometimes even completely dry when it is exposed to the air, and therefore it is very easy for the hole of the cap to probably become clogged by the dry pigment. However, as mentioned earlier, the dye will not generate residue or stick (i.e., thicken) as a result of being entirely evaporated. Moreover, the result of experiments shows that when the pigment and dye are mixed; the above-mentioned shortage of the pigment will be alleviated. In other words, the shortage of pigment resulting from the evaporation action. That is, the mixed ink of the pigment and the dye is much more resilient to becoming thick or dried when it is exposed to the air; therefore the hole of the cap is rarely clogged due to the mixed ink solution.

According to the results of the experiments, in practice, the first inkjet head, which here corresponds to the cap 220 of FIG. 10, will be utilized to output the dye; and the second inkjet head, which here corresponds to the cap 230, will be utilized to output the dye or the pigment. Therefore, the ink in the connecting terminal 222, the tube 250, and the connecting terminal 234 will be the dye. As a result of this configuration it the clogging situation will not be happened. Additionally, an alternate configuration, for example, if the ink outputted from the second inkjet head is the dye, then the connecting terminal 232 and the tube 240 will again successfully avoid the clogging situation. Please consider the example wherein the ink outputted from the second inkjet head is the pigment. According to the present invention, the dye in the first inkjet head will be drained out according to the pump 210 through the connecting terminal 222, tube 250, the connecting terminal 234, the connecting terminal 232 and the tube 240; and at the same time the pigment in the second inkjet head will be drained out according to the pump 210 through the connecting terminal 232 and the tube 240. Therefore, the dye from the first inkjet head and the pigment from the second inkjet head will be mixed at the connecting terminal 232. According to the above-mentioned result, the mixed ink is less likely (i.e., more resilient) to becoming thick and dried out; therefore, the connecting terminal 232 and the tube 240 will not become clogged.

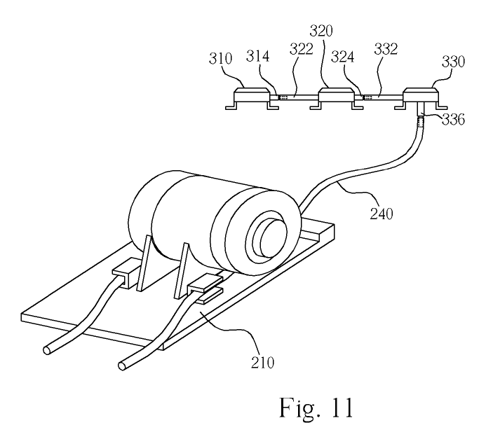

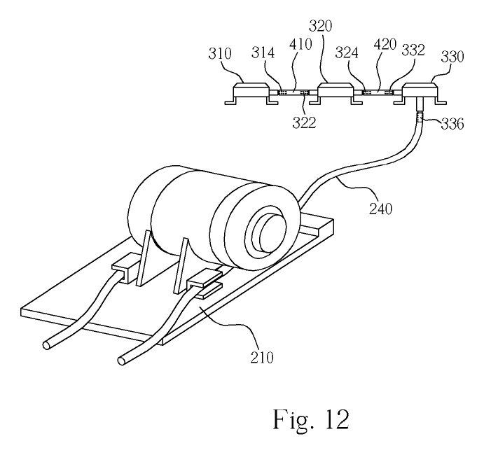

Moreover, the ink discharge device in the present invention is not limited to only two caps as described previously. Please refer to FIG. 11. FIG. 11 illustrates a diagram of the connection within three caps according to the third embodiment of the present invention. As shown in FIG. 11, the connecting terminal 314 of the cap 310 is directly connected to the connecting terminal 322 of the cap 320; the other connecting terminal 324 of the cap 320 is directly connected to the connecting terminal 332 of the cap 330; and the connecting terminal 336 of the cap 330 is directly connected to the pump 210. Additionally, please consider another situation by referring to FIG. 12. FIG. 12 illustrates a diagram showing the connection within three caps according to the four embodiment of the present invention. In this embodiment, the connecting terminal 314 of the cap 310 is connected to the connecting terminal 322 of the cap 320 through the tube 410; the connecting terminal 324 of the cap 320 is connected to the connecting terminal 332 of the cap 330 through the tube 420; and the other connecting terminal 336 of the cap 330 is further connected to the pump 210. Similarly, in order to avoid the situation of clogged ink of the connecting terminal and the tube, the ink corresponding to the last cap (e.g., the cap 310) should be the dye type ink, and the ink corresponding to the other caps then can be the dye type ink or the pigment type ink. Please note that, the number of cap are not limited in the present invention to those configurations disclosed here. That is, the disclosed configurations are offered as examples over and not meant to be limitations, and in other embodiments, more than three caps can be assigned with the same connecting manner depend on the design requirements at hand.

In conclusion, the present invention can prevent a related connecting terminal or a related tube of a cap from being clogged according to ways of changing the connection between the cap and the pump and considering the characteristic of the ink.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An ink discharge device of a printing device, comprising:
a first cap for covering a first nozzle area of the printing device, the first cap comprising
a first connecting terminal and a second connecting terminal;
a second cap for covering a second nozzle area of the printing device, the second cap comprising a third connecting terminal coupled to the second connecting terminal; and
a pump coupled to the first connecting terminal for discharging the ink on the first and the second nozzle areas through the first and the second caps.

2. The ink discharge device of claim 1, further comprising:
a tube, wherein the two ends of the tube are respectively connected to the first connecting terminal and the pump.

3. The ink discharge device of claim 1, further comprising:
a tube, wherein the two ends of the tube are respectively connected to the second connecting terminal and the third connecting terminal.

4. The ink discharge device of claim 1, wherein the first nozzle area is utilized for outputting the pigment or the dye; and the second nozzle area is utilized for outputting the dye.

5. The ink discharge device of claim 1, further comprising:
a third cap for covering a third nozzle area of the printing device, the third cap comprising a fourth connecting terminal coupled to the third connecting terminal; and a fifth connecting terminal coupled to the second connecting terminal;
wherein the pump discharges the ink on the first, the second, and the third nozzle areas through the first, the second, and the third caps.

6. The ink discharge device of claim 5, further comprising:
a plurality of tubes coupled between the fourth connecting terminal and the third connecting terminal and between the fifth connecting terminal and the second connecting terminal respectively.

7. The ink discharge device of claim 5, wherein the first nozzle area is utilized for outputting the pigment or the dye; the second nozzle area is utilized for outputting the dye; and the third nozzle area is utilized for outputting the pigment or the dye.
